(19) United States
(12) Patent Application Publication
(10) Pub. No.: US 2015/0194921 A1
(43) Pub. Date: Jul. 9, 2015

(54) MOTOR CONTROL DEVICE CAPABLE OF SWITCHING BETWEEN APPLICATION AND NON-APPLICATION OF MAGNETIC FLUX CONTROL

(71) Applicant: FANUC CORPORATION, Yamanashi (JP)

(72) Inventors: Shoutarou Hashimoto, Yamanashi (JP); Tadashi Okita, Yamanashi (JP)

(21) Appl. No.: 14/590,047

(22) Filed: Jan. 6, 2015

(30) Foreign Application Priority Data
Jan. 7, 2014 (JP) 2014-000875

(51) Int. Cl. H02P 25/02; H02P 23/06

(52) U.S. Cl. CPC H02P 25/02; H02P 23/065

(57) ABSTRACT

A motor control device that controls an exciting current and a torque current separately from each other, and drives an induction machine includes: a first exciting current command generating unit that generates a first exciting current command in accordance with a speed and torque command; a second exciting current command generating unit that includes a magnetic flux control unit generating a second exciting current command by using a difference between a first exciting current command and a magnetic flux estimation value, and a magnetic flux estimating unit generating a magnetic flux estimation value from the second exciting current command, the second exciting current command generating unit outputting a second exciting current command; and a switching unit that selects one of a first exciting current command and a second exciting current command in accordance with a control mode or external information.

### BACKGROUND OF THE INVENTION

1. Field of the Invention

The present invention relates to a motor control device, and in particular to a motor control device capable of switching between application and non-application of magnetic flux control.

2. Description of Related Art

FIG. 7 is a block diagram illustrating a basic configuration of an induction machine (motor) control system.

The induction machine control system includes an exciting current command generating unit 61 that generates an exciting current command, an exciting current difference calculating unit 62 that calculates a difference between an exciting current command and an exciting current component detected in an induction machine 100, an exciting current control unit 63 that generates a voltage command on the basis of an electric current difference, a torque current command generating unit 71 that generates a torque current command, a torque current difference calculating unit 72 that calculates a difference between a torque current command and a torque current component detected in the induction machine 100, a torque current control unit 73 that generates a voltage command on the basis of a torque current difference, and a coordinate transforming unit 80 that transforms, into information in a stator coordinate system, information of a magnetic field coordinate system (rotating magnetic field) including a current command that is output by the exciting current control unit 63 and a current command that is output by the torque current control unit 73. Calculations in the magnetic field system are digitally performed, and information in the magnetic field coordinate system is digital data. Information in the stator coordinate system is an analogue signal at the stages of input to and output from the induction machine 100, but is not limited to this, and these are referred to as information in some cases for the sake of simple description. Output from the coordinate transforming unit 80 is PWM-controlled, and is supplied to the induction machine (motor) 100 via a power converter. Here, the coordinate transforming unit 80 transforms two-phase information in the magnetic field coordinate system into three-phase information in the stator coordinate system, and transforms, into two-phase information in the magnetic field coordinate system, exciting current component information and torque current component information that are three-phase information in the stator coordinate system.

In the induction machine control system, it is assumed that generating an exciting current command and a torque command and controlling the induction machine 100 in accordance with these commands achieve a state conforming to the commands in the induction machine 100. In the control system in FIG. 7, an exciting current command generated by the exciting current command generating unit 61 is input directly to the exciting current control unit 63. This means that an exciting current command is treated as a magnetic flux command value in the control system of FIG. 7. In other words, it is assumed that relation that an exciting current command is equal to a magnetic flux command is established, and in addition, an actual magnetic flux follows a magnetic flux command without delay. An exciting current command is input as a magnetic flux command value not only to the exciting current control unit 63, but also to some calculating units.

FIG. 8A is a diagram illustrating an example of a property of an ideal magnetic flux value to a magnetic flux command (exciting current command) that changes (rises) stepwise in the control system of FIG. 7. FIG. 8B is a diagram illustrating an example of a property of an actual magnetic flux in response to a magnetic flux command (exciting current command) that changes (rises) stepwise in the control system of FIG. 7.

In FIG. 8A, the broken line indicates a magnetic flux command (exciting current command) rising stepwise, and the solid line indicates an ideal magnetic flux value in the control system of FIG. 7. As described above, in the control system of FIG. 7, an exciting current command is treated as a magnetic flux command value, and a magnetic flux follows the command without delay, and is considered to be the same as a magnetic flux command rising stepwise. However, in drive control of an actual induction machine, rising of a secondary magnetic flux of the induction machine is slow, and that behavior is not exhibited.

In FIG. 8B, the broken line indicates a magnetic flux command (exciting current command) rising stepwise, and the solid line indicates a magnetic flux that is actually generated in the induction machine 100 in accordance with a magnetic flux command rising stepwise. As illustrated in FIG. 8A and FIG. 8B, in the control system of FIG. 7, a magnetic flux generated in the actual induction machine tends to rise with delay from a magnetic flux command. In a period before a magnetic flux actually rises, a difference between a magnetic flux estimation value and an actual magnetic flux is generated. For this reason, accurate control may not be performed. At this time, a problem, for example, that a swell is generated in output of the induction machine may occur.

In contrast, there is known a method in which as described in Japanese Laid-open Patent Publication No. 2013-066342 and “Theory and Practical Designing of AC Servo System (FIG. 5.23, page 122, 7th edition, Sougou Denshi Publishing Company)”, a magnetic flux control is applied to stabilize output.

FIG. 9 is a block diagram illustrating a configuration of an induction machine control system to which a magnetic flux control system has been applied.

The induction machine control system to which the magnetic flux control system has been applied is provided with a magnetic-flux-control exciting current command generating unit including a magnetic flux command generating unit 64, a magnetic flux difference calculating unit 65, a magnetic flux estimating unit 66, and a magnetic flux control unit 67, instead of the exciting current command generating unit 61 in the control system of FIG. 7. The magnetic flux command generating unit 64 generates a magnetic flux command. A magnetic flux command generated by the magnetic flux command generating unit 64 is the same information as an exciting current command generated by the exciting current command generating unit 61. The magnetic flux difference calculating unit 65 calculates a magnetic flux difference between a magnetic flux command generated by the magnetic flux command generating unit 64 and a magnetic flux estimation value generated by the magnetic flux estimating unit 66. The magnetic flux control unit 67 generates an exciting current command from a magnetic flux difference output by the magnetic flux difference calculating unit 65, and outputs the generated exciting current command to the exciting current difference calculating unit 62. The magnetic flux estimating unit 66 generates a magnetic flux estimation value from an exciting current command output by the magnetic flux control unit 67.

FIG. 10 is a diagram illustrating an example of a magnetic flux estimation value that is generated by the magnetic flux estimating unit 66 in response to an exciting current command rising stepwise.

The magnetic flux estimating unit 66 generates a value that is estimation of a magnetic flux actually generated in the induction machine 100 in accordance with change in a value of a magnetic flux command, taking into consideration delay in rising of actual magnetic flux in the induction machine 100 as illustrated in FIG. 8B. Thereby, an exciting current command generated by the magnetic flux control unit 67 always becomes information in which an actually generated magnetic flux is accurately estimated. Also, accurate control can be implemented, and a swell in output can be suppressed.

Here, description will be made on derivation of behavior of a secondary magnetic flux of the induction machine that becomes a base of estimation in the magnetic flux estimating unit 66.

In control of the induction machine, there is known a vector control in which a D-phase current (exciting current) and a Q-phase current (torque current) are separately controlled. In the vector control, equations of the induction motor in D-Q coordinates are expressed by the following (1) to (4).

$$\begin{matrix}\begin{matrix}PRIMARY \text{-} SIDE EQUATION & {V}_{1} = {R}_{1} {I}_{1} + \frac{d}{d t} {Φ}_{1} + ω J {Φ}_{1}\end{matrix} & ( 1 ) \\ \begin{matrix}SECONDARY \text{-} SIDE EQUATION & {V}_{2} = {R}_{2} {I}_{2} + \frac{d}{d t} {Φ}_{2} + {ω}_{s} J {Φ}_{2} = 0\end{matrix} & ( 2 ) \\ \begin{matrix}EQUATION OF MAGNETIC FLUX & {Φ}_{1} = {L}_{1} {I}_{1} + {MI}_{2}\end{matrix} & ( 3 ) \\ {Φ}_{2} = {MI}_{1} + {L}_{2} {I}_{2} \\ {V}_{1} = {( \begin{matrix}{v}_{1 d} & {v}_{1 q}\end{matrix} )}^{T} : PRIMARY VOLTAGE . \\ {V}_{2} = {( \begin{matrix}{v}_{2 d} & {v}_{2 q}\end{matrix} )}^{T} : SECONDARY VOLTAGE , \\ {Φ}_{1} = {( \begin{matrix}{φ}_{1 d} & {φ}_{1 q}\end{matrix} )}^{T} : PRIMARY MAGNETIC FLUX , \\ {Φ}_{2} = {( \begin{matrix}{φ}_{2 d} & {φ}_{2 q}\end{matrix} )}^{T} : SECONDARY MAGNETIC FLUX & ( 4 )\end{matrix}$$

From the above equations (2) and (4), an equation of relation between a secondary magnetic flux and a primary current is obtained as in the equation (5).

$$\frac{d}{d t} ( \begin{matrix}{φ}_{2 d} \\ {φ}_{2 q}\end{matrix} ) = ( \begin{matrix}- {R}_{2} / {L}_{2} & {ω}_{s} \\ - {ω}_{s} & - {R}_{2} / {L}_{2}\end{matrix} ) ( \begin{matrix}{φ}_{2 d} \\ {φ}_{2 q}\end{matrix} ) + \frac{{MR}_{2}}{{L}_{2}} ( \begin{matrix}{i}_{1 d} \\ {i}_{1 q}\end{matrix} ) \qquad ( 5 )$$

In the vector control of the induction machine, it is premised that control is performed such that a secondary Q-phase magnetic flux becomes φ_{2q}=0. At this time, from the above equation (5), the transfer function of the following equation (6) is introduced.

$${φ}_{2 d} = \frac{M}{{L}_{2} / {R}_{2} s + 1} {i}_{1 d} \qquad ( 6 )$$

The equation (6) indicates that rising of a secondary magnetic flux φ₂d is delayed at a time constant L₂/R₂ from an exciting current i_{1d}. Accordingly, the magnetic flux estimating unit 66 receives input of an exciting current, and performs calculation of the equation (6) so that the magnetic flux estimating unit 66 can accurately estimate a secondary magnetic flux of the induction machine. Thus, stabilization of output by the magnetic flux control improves control performance when position control is performed.

When position control is performed, accurate control of torque is important. Since application of the magnetic flux control can suppress a swell in output and a swell in torque, stable torque control becomes possible. Therefore, in position control, control performance can be improved by always applying the magnetic flux control.

FIG. 11A is a diagram illustrating a speed and torque command behavior of the induction machine when rigid tapping operation is performed, and illustrates an example (without magnetic flux control) in which the magnetic flux control is not applied to position control. FIG. 11B is a diagram illustrating a speed and torque command behavior of the induction machine when rigid tapping operation is performed, and illustrates an example (with magnetic flux control) in which the magnetic flux control is applied to position control.

For torque command, there are an upper limit value and a lower limit value. When a torque command reaches the upper limit value or the lower limit value, control performance in position control is deteriorated. For this reason, acceleration of the motor is set such that a toque command stays in a range between the upper limit value and the lower limit value. In order to shorten machining time, acceleration is set as the largest possible value. For this reason, it is desirable that acceleration is adjusted such that a torque command is smaller than the upper limit value, and approaches the upper limit value as close as possible.

When there is no magnetic flux control illustrated in FIG. 11A, a large swell is generated in a torque command, and a torque command peak generated by the swell reaches the upper limit value thereof. A torque command other than speed when the torque command peaks has a margin to the upper limit value. However, for the peak value to not exceed the upper limit value, acceleration of the motor may not be set as a still larger value.

When there is magnetic flux control illustrated in FIG. 11B, a swell in torque command is suppressed so that a torque command can be adjusted such that a torque command in an entire speed range is increased to a value close to the upper limit value. Accordingly, acceleration can be set as a value larger than a case when there is no magnetic flux control, and machining time can be considerably shortened.

Meanwhile, also in speed control, in some cases, application of the magnetic flux control is desirable. A description will be made for this matter.

FIG. 12A is a diagram illustrating an example of change in output at the time of acceleration when output of the motor is limited in the speed control, and illustrates a case of absence of the magnetic flux control. FIG. 12B illustrates an example of change in output at the time of acceleration when output of the motor is limited in the speed control, and illustrates a case of presence of the magnetic flux control. In FIG. 12A and FIG. 12B, the solid line indicates a case of absence of output limitation, the dotted line indicates a case of an output limit value of 13 kW, and the broken line indicates a case of an output limit value of 9 kW.

In a certain case, maximum output of the motor is limited due to a power supply capacity. In the absence of the magnetic flux control, as illustrated in FIG. 12A, in the motor whose output has a large swell, a peak of output caused by a swell can largely exceed the limitation target value. In this case, when output is limited such that a peak of output is settled at the limitation target value, the limitation becomes excessive, and acceleration time is increased.

In contrast, application of the magnetic flux control can decrease fluctuation in output, compared with the case without the application, as illustrated in FIG. 12B. Thus, the magnetic flux control suppresses a swell in output, and enables accurate output limitation of acceleration and deceleration in the speed control. Thereby, extra limitation of output becomes unnecessary, and acceleration time can be shortened.

FIG. 13 is a diagram illustrating comparison of output change of the induction machine between presence and absence of the magnetic flux control in acceleration at the time that the maximum rotational frequency is increased from 0 to 8000 min⁻¹ (8000 rpm) when the position control is not performed, but speed control is performed. FIG. 14 illustrates comparison of speed change between presence and absence of the magnetic flux control on the same condition. In FIG. 13 and FIG. 14, the solid line indicates the case without the magnetic flux control, and the dotted line indicates the case with the magnetic flux control.

As illustrated in FIG. 13, in the absence of the magnetic flux control, output is decreased by a swell in the middle of the acceleration, and in a speed range after 3000 min⁻¹ (approximately 650 ms), average output in a case when there is magnetic flux control becomes larger. Accordingly, as illustrated in FIG. 14, time for acceleration up to the speed range after 3000 min⁻¹ in a case when there is magnetic flux control becomes shorter. Thus, when the position control is not performed, but the speed control is performed, a large swell in output causes long acceleration time in acceleration up to the high speed. For this reason, the magnetic flux control is applied to suppress a swell in output, and acceleration performance can be improved.

However, in the absence of the magnetic flux control, as illustrated in FIG. 13, in acceleration in a low speed range before 3000 min⁻¹, output swells and becomes high. Accordingly, as illustrated in FIG. 14, acceleration time can become short. For this reason, there is a problem that application of the magnetic flux control leads to deterioration in acceleration performance.

As described above, in the absence of the magnetic flux control, a swell is generated in output, and there is a variation in that acceleration time becomes long or short depending on a speed. Meanwhile, in the presence of the magnetic flux control, a swell in output becomes small, so that a variation in acceleration time due to a speed does not occur, and acceleration time, however, can become longer than in the case without the magnetic flux control. For this reason, in the speed control in which acceleration time is regarded as important, it may be better to not apply the magnetic flux control.

### SUMMARY OF THE INVENTION

In view of the above, an object of the present invention is to realize a motor control device capable of performing optimum control in accordance with a status of use.

In order to realize the above-described object, a motor control device is a motor control device that controls an exciting current and a torque current separately from each other, and drives an induction machine, the motor control device including: a first exciting current command generating unit generating a first exciting current command in accordance with a speed and torque current value; a second exciting current command generating unit including a magnetic flux command generating means for generating a magnetic flux command in accordance with the speed and torque current value, a magnetic flux control unit that generates a second exciting current command by using a difference between the magnetic flux command and a magnetic flux estimation value, and a magnetic flux estimating unit that generates the magnetic flux estimation value from the second exciting current command, wherein the second exciting current command generating unit outputs the second exciting current command; and a switching unit selecting one of the first exciting current command and the second exciting current command in accordance with a control mode or external information.

When speed control is being performed on the induction machine, the switching unit selects the first exciting current command, and when position control is being performed on the induction machine, the switching unit selects the second exciting current command.

The motor control device receives the external information for selecting the first exciting current command and the second exciting current command, selects the first exciting current command when the external information is not input, and selects the second exciting current command when the external information is input.

### BRIEF DESCRIPTION OF THE DRAWINGS

The present invention will be understood more clearly by referring to the attached drawings in which:

FIG. 1A is a block diagram illustrating a configuration of an induction machine control system according to an embodied example, and illustrates the configuration of the induction machine control system;

FIG. 1B is a block diagram illustrating a configuration of an induction machine control system according to an embodied example, and illustrates the configuration of a second exciting current command generating unit;

FIG. 2 is a flowchart illustrating operation relating to an exciting current command switching unit of the induction machine control system of the embodied example;

FIG. 3 is a diagram illustrating a configuration in which a result of “state determination” for switching selection of the exciting current command switching unit is replaced to a result of “determination as to which of position control and speed control is being performed” in the induction machine control system according to an embodied example;

FIG. 4 is a flowchart illustrating operation in the induction machine control system of the embodied example, when switching the exciting current command switching unit in accordance with the above-mentioned result of “determination as to which of position control and speed control is being performed”;

FIG. 5 is a diagram illustrating a configuration in the induction machine control system according to an embodied example, when switching selection of the exciting current command switching unit in accordance with external information;

FIG. 6 is a flowchart illustrating operation when switching the exciting current command switching unit in accordance with the above-mentioned external information in the induction machine control system of the embodied example;

FIG. 7 is a block diagram illustrating a basic configuration of an induction machine control system;

FIG. 8A is a diagram illustrating an example of a property of an ideal magnetic flux to a magnetic flux command (exciting current command) that changes (rises) stepwise in the control system of FIG. 7;

FIG. 8B is a diagram illustrating an example of a property of an actual magnetic flux in response to a magnetic flux command (exciting current command) that changes (rises) stepwise in the control system of FIG. 7;

FIG. 9 is a block diagram illustrating a configuration of an induction machine control system to which a magnetic flux control system has been applied;

FIG. 10 is a diagram illustrating an example of a magnetic flux estimation value that is generated by a magnetic flux estimating unit in response to an exciting current command rising stepwise;

FIG. 11A is a diagram illustrating a speed and torque command behavior of the induction machine when rigid tapping operation is performed, and illustrates an example (without magnetic flux control) in which the magnetic flux control is not applied to position control;

FIG. 11B is a diagram illustrating a speed and torque command behavior of the induction machine when rigid tapping operation is performed, and illustrates an example (with magnetic flux control) in which the magnetic flux control is applied to position control;

FIG. 12A is a diagram illustrating an example of change in output at the time of acceleration when output of a motor is limited in speed control, and illustrates a case of absence of the magnetic flux control;

FIG. 12B is a diagram illustrating an example of change in output at the time of acceleration when output of the motor is limited in the speed control, and illustrates a case with the magnetic flux control;

FIG. 13 is a diagram illustrating comparison of output change of the induction machine between presence and absence of the magnetic flux control in acceleration at the time that the maximum rotational frequency is increased from 0 to 8000 min⁻¹ (8000 rpm) when the position control is not performed, but only speed control is performed; and

FIG. 14 is a diagram illustrating comparison of speed change of the induction machine between presence and absence of the magnetic flux control in acceleration at the time that the maximum rotational frequency is increased from 0 to 8000 min⁻¹ (8000 rpm) when the position control is not performed, but only speed control is performed.

### DETAILED DESCRIPTION

In the following, a motor control device capable of performing switching between presence and absence of application of magnetic flux control will be described with reference to the drawings. However, it is to be understood that the present invention is not limited to an embodiment illustrated in the drawings or described in the following.

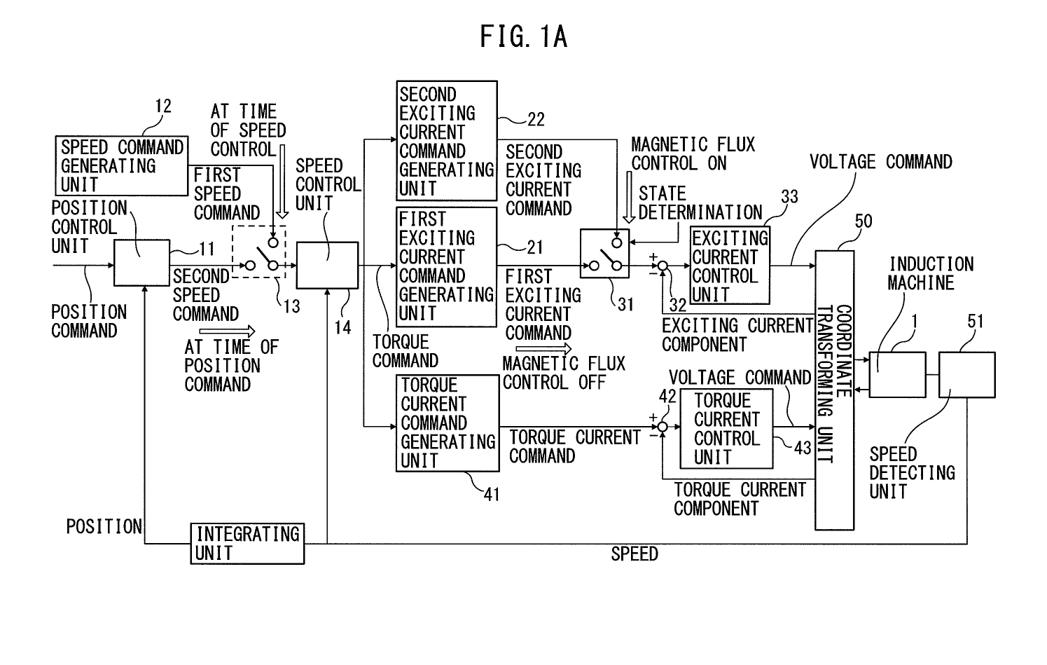

FIG. 1A is a block diagram illustrating a configuration of an induction machine control system according to an embodied example, and illustrates the configuration of the induction machine control system. FIG. 1B is a block diagram illustrating a configuration of an induction machine control system according to an embodied example, and illustrates a second exciting current command generating unit.

The induction machine control system according to the embodied example controls an induction machine 1.

The induction machine control system includes a position control unit 11, a speed command generating unit 12, a speed command switching unit 13, a speed control unit 14, a first exciting current command generating unit 21, a second exciting current command generating unit 22, an exciting current command switching unit 31, an exciting current difference calculating unit 32, an exciting current control unit 33, a torque current command generating unit 41, a torque current difference calculating unit 42, a torque current control unit 43, and a coordinate transforming unit 50.

The position control unit 11 generates a second speed command for rotation to a position commanded by a position command, from a position command that is external information and rotational position information of the induction machine 1 that is obtained by integrating feedback data from a motor speed detecting unit 51. The speed command generating unit 12 generates a first speed command for rotation at a speed commanded in accordance with a speed command that is external information. The speed command switching unit 13 performs switching such that a first speed command is input to the speed control unit 14 at the time of the speed control, and a second speed command is input to the speed control unit 14 at the time of the position control.

The speed control unit 14 generates a torque command for rotation at a commanded speed, from one of the first speed command and the second speed command, and speed information of the induction machine 1 from the motor speed detecting unit 51. The torque command is input to the first exciting current command generating unit 21, the second exciting current command generating unit 22, and the torque current command generating unit 41.

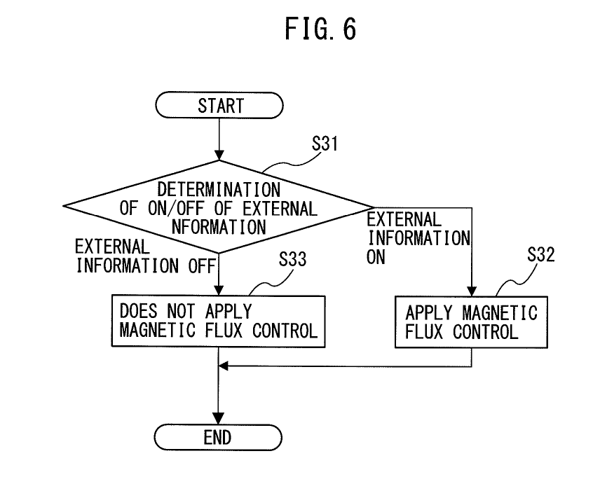

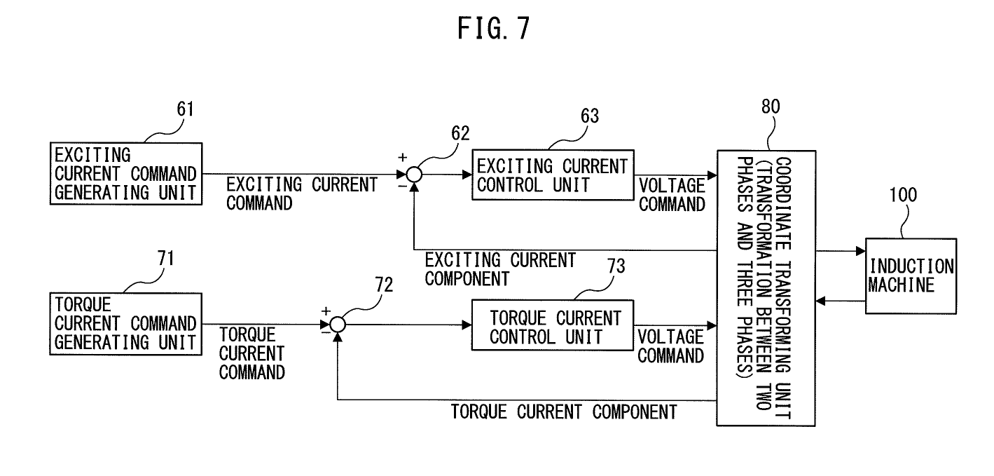

The first exciting current command generating unit 21 generates a first exciting current command in accordance with the torque command, and outputs the first exciting current command to the exciting current command switching unit 31. The first exciting current command is the same command as an exciting current command generated by the exciting current command generating unit 61 in FIG. 7, and is a magnetic flux axis component in a magnetic field coordinate system for causing desired rotation, for example.

As illustrated in FIG. 1B, the second exciting current command generating unit 22 includes a magnetic flux command generating unit 24, a magnetic flux difference calculating unit 25, a magnetic flux estimating unit 26, and a magnetic flux control unit 27.

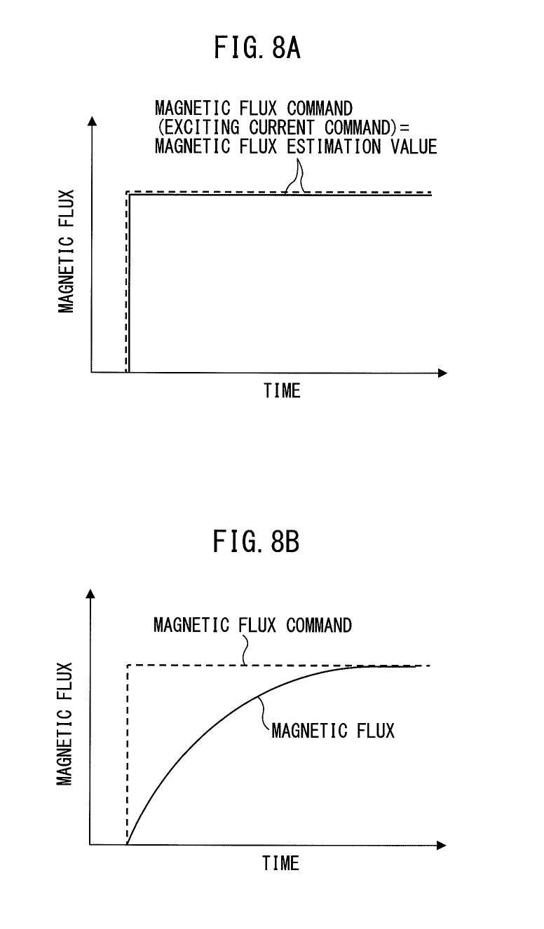

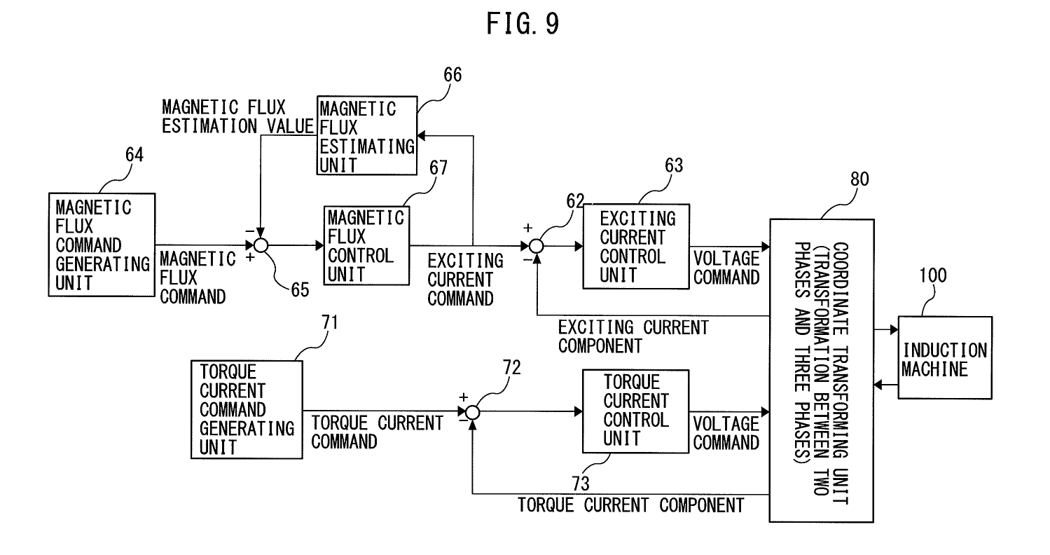

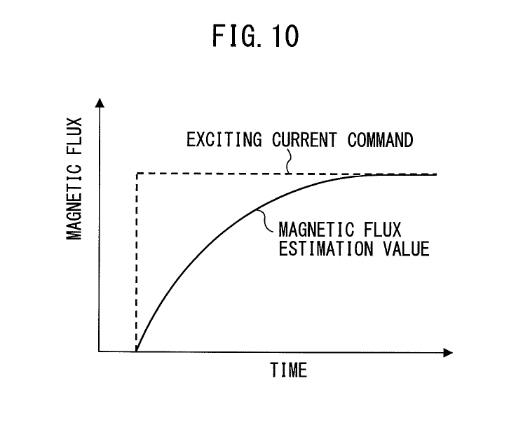

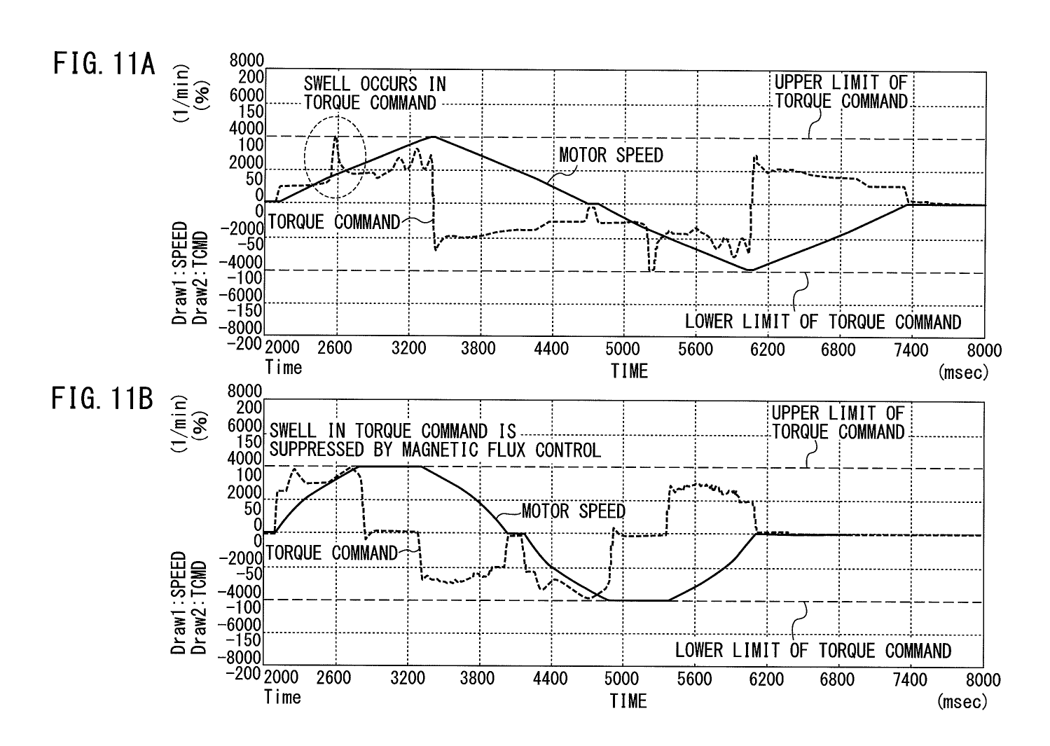

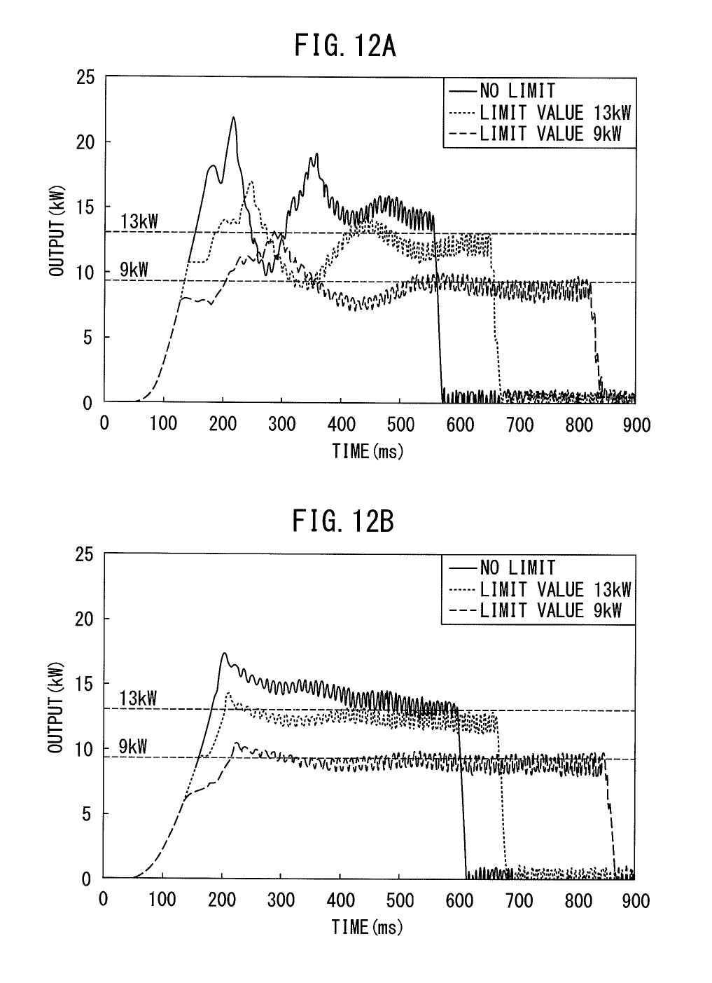

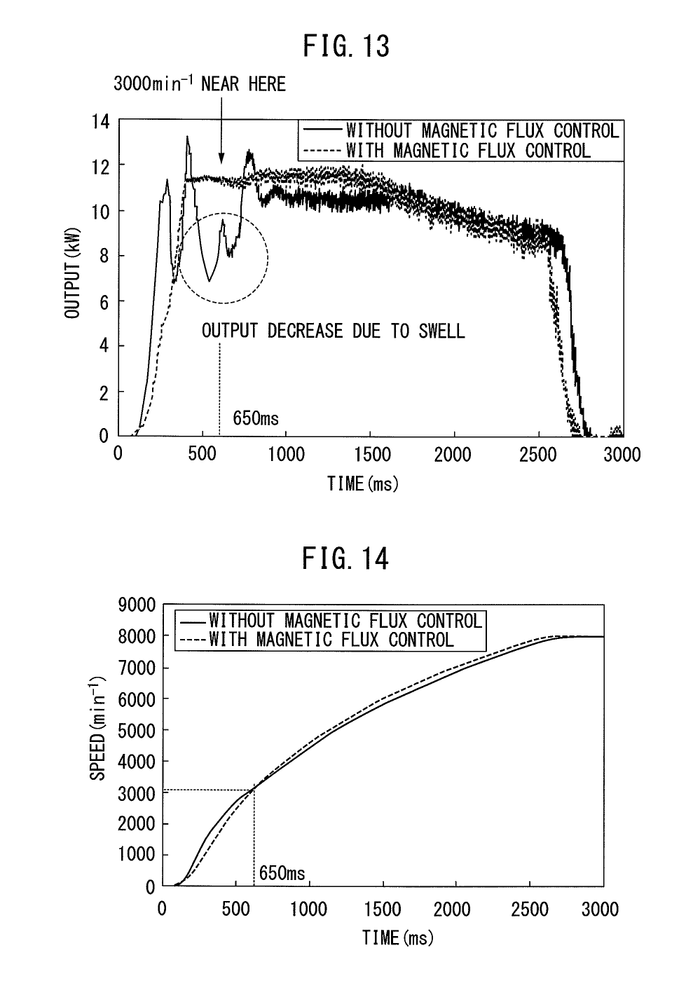

The magnetic flux command generating unit 24 generates a magnetic flux command in accordance with the torque command. For example, the magnetic flux command generated by the magnetic flux command generating unit 24 may be the same command as the first exciting current command generated by the first exciting current command generating unit 21. In this case, without providing the magnetic flux command generating unit 24, the first exciting current command generated by the first exciting current command generating unit 21 may be used. The magnetic flux difference calculating unit 25 calculates a magnetic flux difference between the magnetic flux command generated by the magnetic flux command generating unit 24 and a magnetic flux estimation value generated by the magnetic flux estimating unit 26. The magnetic flux control unit 27 generates a second exciting current command from the magnetic flux difference output by the magnetic flux difference calculating unit 25, and outputs the second exciting current command to the exciting current command switching unit 31 and the magnetic flux estimating unit 26. The magnetic flux estimating unit 26 generates the magnetic flux estimation value from the second exciting current command output by the magnetic flux control unit 27. As described above, the second exciting current command generating unit 22 has the same configuration as the magnetic-flux-control exciting current command generating unit in FIG. 9.

The exciting current command switching unit 31 performs switching such that either the first exciting current command or the second exciting current command is input to the exciting current difference calculating unit 32, in accordance with information concerning a result of “state determination”.

The exciting current difference calculating unit 32 calculates an exciting current difference between either the first exciting current command or the second exciting current command selected by the exciting current command switching unit 31 and an exciting current component detected in the induction machine 1. The exciting current control unit 33 generates a voltage command on the basis of the exciting current difference output by the exciting current difference calculating unit 32.

The torque current command generating unit 41 generates a torque current command from the torque command output by the speed control unit 14. The torque current difference calculating unit 42 calculates a torque current difference between the torque current command and a torque current component detected in the induction machine 1. The torque current control unit 43 generates a voltage command on the basis of the torque current difference.

The coordinate transforming unit 50 transforms, into information in a stator coordinate system, information in a magnetic field system (rotating magnetic field) including the voltage command output by the exciting current control unit 33 and the voltage command output by the torque current control unit 43. Output from the coordinate transforming unit 50 is PWM-controlled to be supplied to the induction machine 1 via a power converter. In this example, the coordinate transforming unit 50 transforms two-phase information in the magnetic field coordinate system into three-phase information in the stator coordinate system. The coordinate transforming unit 50 transforms the exciting current component and the torque current component in the stator coordinate system into information in the magnetic field system.

As described above, when the exciting current command switching unit 31 selects the first exciting current command, the induction machine control system of the embodied example forms a control system illustrated in FIG. 7 to which the magnetic flux control is not applied, and when the exciting current command switching unit 31 selects the second exciting current command, the induction machine control system of the embodied example forms a control system illustrated in FIG. 9 to which the magnetic flux control is applied.

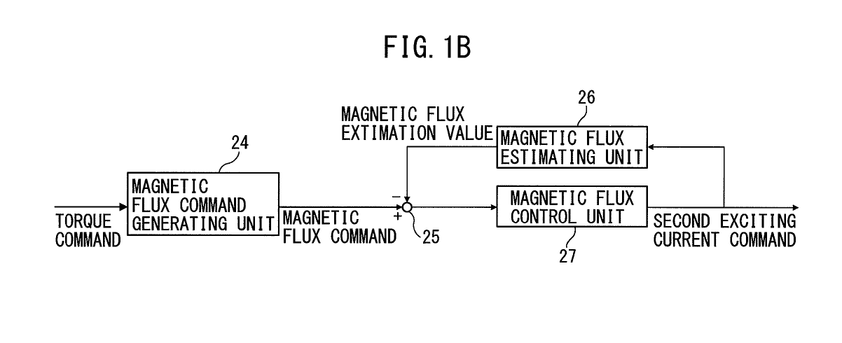

FIG. 2 is a flowchart illustrating operation relating to the exciting current command switching unit 31 of the induction machine control system of the embodied example.

At step S11, a state is determined. When the state is a state 1, the operation proceeds to step S12, and when the state is a state 2, the operation proceeds to a state S13.

At step S12, the exciting current command generating unit 31 selects a second exciting current command, whereby forming the control system (with the magnetic flux) to which the magnetic flux control is applied.

At step S13, the exciting current command generating unit 31 selects a first exciting current command, whereby forming the control system (without the magnetic flux) to which the magnetic flux control is not applied. Control of the speed command switching unit 13 is arbitrarily set, and has no specific connection with the control of steps S12 and S13.

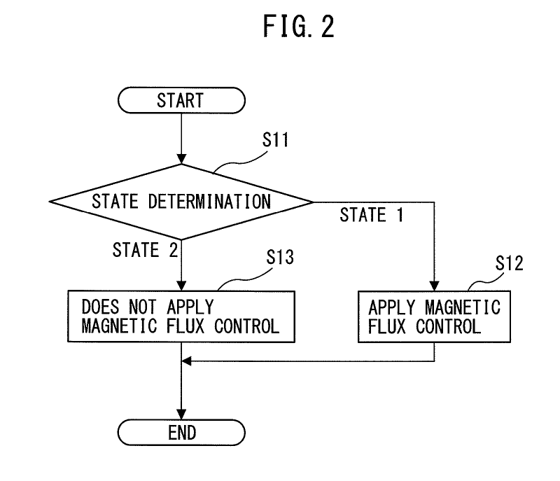

FIG. 3 is a diagram illustrating a configuration in which a result of “state determination” for switching selection of the exciting current command switching unit 31 is replaced to a result of “determination as to which of position control and speed control is being performed” in the induction machine control system according to an embodied example.

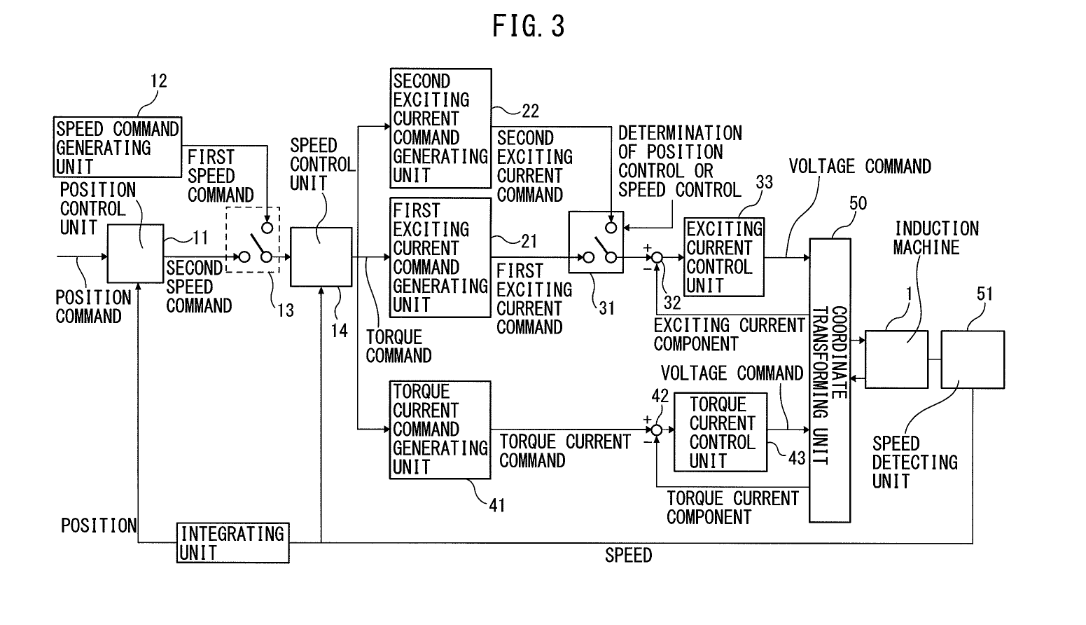

FIG. 4 is a flowchart illustrating operation when switching the exciting current command switching unit 31 in accordance with the above-mentioned result of “determination as to which of position control and speed control is being performed” in the induction machine control system of the embodied example.

At step S21, “determination as to which of position control and speed control is being performed” is made, and when the determination result is position control, the operation proceeds to step S22, and when the determination result is speed control, the operation proceeds to step S23.

At step S22, the exciting current command switching unit 31 selects a second exciting current command, whereby forming the control system (with magnetic flux control) to which the magnetic flux control is applied. At this time, the speed command switching unit 13 selects a second speed command to cause the second speed command to be input to the speed control unit 14. Thereby, the induction machine control system according to the embodied example forms the control system that performs position control with the magnetic flux control.

At step S23, the exciting current command switching unit 31 selects a first exciting current command, and forms the control system (without the magnetic flux control) to which the magnetic flux control is not applied. At this time, the speed command switching unit 13 selects a first speed command to cause the first speed command to be input to the speed control unit 14. Thereby, the induction machine control system according to the embodied example forms the control system that performs speed control without the magnetic flux control.

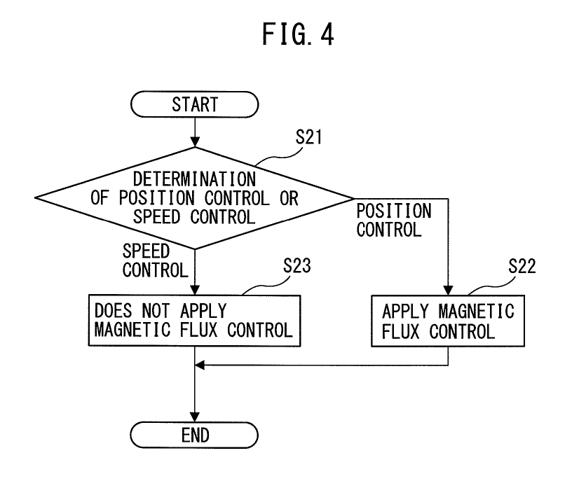

FIG. 5 is a diagram illustrating a configuration when switching selections of the exciting current command switching unit 31 in accordance with external information, in the induction machine control system according to an embodied example.

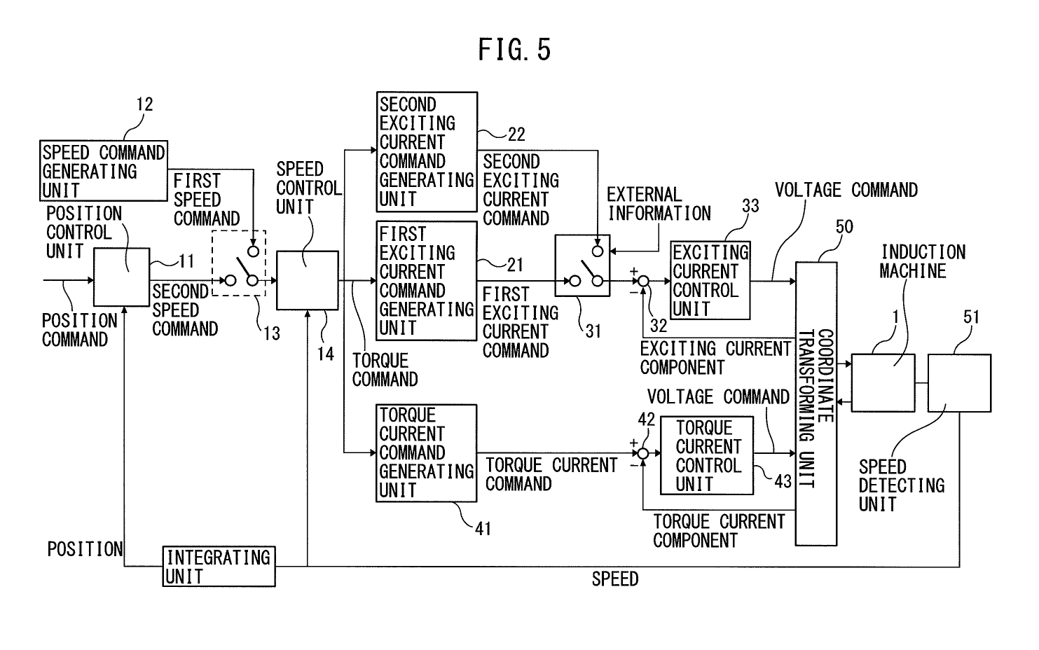

FIG. 6 is a flowchart illustrating operation when switching the exciting current command switching unit 31 in accordance with the above-mentioned external information in the induction machine control system of the embodied example.

At step S31, it is determined whether external information is ON (is input) or OFF (is not input). When the external information is ON, the operation proceeds to step S32, and when the external information is OFF, the operation proceeds to step S33.

At step S32, the exciting current command switching unit 31 selects a second exciting current command, whereby forming the control system (with the magnetic flux control) to which the magnetic flux control is applied.

At step S33, the exciting current command switching unit 31 selects a first exciting current command, whereby forming the control system (without the magnetic flux control) to which the magnetic flux control is not applied.

Control of the speed command switching unit 13 is arbitrarily set, and has no specific connection with control of steps S32 and S33.

For example, it is assumed that control is performed when rotation of the induction machine 1 is started, such that the speed control without the magnetic flux control is performed for a predetermined period of time right after the start-up of the rotation, and then, the speed control with the magnetic flux control is performed, and after the rotation becomes high-speed to some extent, the position control with the magnetic flux control is performed. In this case, setting is made such that for the predetermined period of time after the start-up, external information is made OFF, and the speed command switching unit 13 selects a first speed command to perform the speed control without the magnetic flux control. After elapse of the predetermined period of time, a state in which external information is made ON and the speed command switching unit 13 selects a first speed command is maintained to perform the speed control with the magnetic flux control. Further, after that, a state in which external information is kept ON, and the speed command switching unit 13 selects a second speed command is made so that the position control with the magnetic flux control is performed. This enables the control system in which when rotation of the induction machine 1 is started, high acceleration can be obtained, and when the speed becomes fast to some extent, stable rotation can be performed.

Although the embodiment of the present invention is described above, the described embodiment is for description of the present invention, and a person skilled in the art can easily understand that various modified examples can be made within the scope of claims.

According to the present invention, the case of applying the magnetic flux control and the case of not applying the magnetic flux control can be selected, so that the motor control device capable of performing the optimum control in accordance with a status of use can be implemented.

For example, at the time of the position control, the switching unit is switched so as to select a second exciting current command, and the magnetic flux control is performed. Meanwhile, at the time of the speed control, the switching unit is switched so as to select a first exciting current command such that the magnetic flux control is not performed. Further, switching between presence and absence of the magnetic flux control according to external information is made possible whereby, also in the speed control, when control performance is required, external information is input so that the magnetic flux control is made effective.

What is claimed is:

1. A motor control device that controls an exciting current and a torque current separately from each other, and drives an induction machine, the motor control device comprising:
a first exciting current command generating unit generating a first exciting current command in accordance with a speed and torque command;
a second exciting current command generating unit including a magnetic flux command generating unit that generates a magnetic flux command in accordance with the speed and torque command, a magnetic flux control unit that generates a second exciting current command by using a difference between the magnetic flux command and a magnetic flux estimation value, and a magnetic flux estimating unit that generates the magnetic flux estimation value from the second exciting current command, wherein the second exciting current command generating unit outputs the second exciting current command; and
a switching unit selecting one of the first exciting current command and the second exciting current command in accordance with a control mode or external information.

2. The motor control device according to claim 1, wherein when speed control is being performed on the induction machine, the switching unit selects the first exciting current command, and
when position control is being performed on the induction machine, the switching unit selects the second exciting current command.

3. The motor control device according to claim 1, wherein the motor control device
receives the external information for selecting the first exciting current command and the second exciting current command;
when the external information is not input, selects the first exciting current command; and
when the external information is input, selects the second exciting current command.
